(19) United States
(12) Patent Application Publication
(10) Pub. No.: US 2019/0384068 A1
(43) Pub. Date: Dec. 19, 2019

(54) DISPLAY DEVICE

(71) Applicant: KOREA INSTITUTE OF SCIENCE AND TECHNOLOGY, Seoul (KR)

(72) Inventors: Soongi PARK, Seoul (KR); Sungkyu KIM, Seoul (KR)

(73) Assignee: KOREA INSTITUTE OF SCIENCE AND TECHNOLOGY, Seoul (KR)

(21) Appl. No.: 16/414,817

(22) Filed: May 17, 2019

(30) Foreign Application Priority Data
Jun. 18, 2018 (KR) 10-2018-0069874

(51) Int. Cl. G02B 27/26; G02B 27/22

(52) U.S. Cl. CPC G02B 27/26; G02B 27/2221

(57) ABSTRACT

Provided is a display device including an image providing device configured to provide an image, a polarization modulation device configured to modulate a polarization state of each pixel in the image provided by the image providing device according to pixel-specific depth information of the image, and a birefringent optical system configured to focus the image at focal lengths determined according to the polarization state modulated by the polarization modulation device.

### CROSS-REFERENCE TO RELATED APPLICATION

This application claims priority to and the benefit of Korean Patent Application No. 10-2018-0069874, filed on Jun. 18, 2018, the disclosure of which is incorporated herein by reference in its entirety.

### BACKGROUND

### 1. Field of the Invention

The present invention relates to a display device, and more particularly, to a polarization modulating multifocal head-mounted display (HMD) which adjusts a focal length according to a polarization state.

### 2. Discussion of Related Art

Existing augmented reality (AR) or virtual reality (VR) HMDs which are commercialized products may provide binocular parallax stereoscopic images but cause headache, dizziness, and motion sickness due to limitations on depth representation and visual fatigue. To overcome the limitations on depth representation, a polarization modulating multilayer display method was suggested. The existing polarization modulating multilayer display method enables focus adjustment but involves a large volume because it is necessary to use a projection optical system. Therefore, it is difficult to apply the polarization modulating multilayer display method to an HMD for implementing VR and AR. Also, since contrast of a video is low due to characteristics of polarized scattering waves and the video is blurred by multiple scattering, quality of the video is degraded.

### PATENT LITERATURE

(Patent Literature 1) Korean Unexamined Patent Application Publication No. 10-2011-0107988

### Non-Patent Literature

(Non-Patent Literature 1) CK. Lee et al., “Compact three-dimensional head-mounted display system with Savart plate,” Opt. Express 24, 19531-19544 (2016)
(Non-Patent Literature 2) J. Hong et al., “Integral floating display systems for augmented reality,” Appl. Opt., vol. 51, no. 18, pp. 4201-4209, June 2012.
(Non-Patent Literature 3) F. Huang et al., “The light field stereoscope: Immersive computer graphics via factored near-eye light field displays with focus cues,” ACM SIGGRAPH, vol. 33, no. 5, 2015.

### SUMMARY OF THE INVENTION

The present invention is directed to providing a multifocal three-dimensional (3D) display device which employs an image providing device, such as a display panel, combines an image provided by the image providing device with depth information obtained by polarizing the image through a polarization modulation device, such as a liquid crystal modulator, and provides two or more focal lengths, at which an image is formed, according to polarization and depth information of the image using a birefringent optical system for providing different focal lengths according to polarization states.

According to an aspect of the present invention, there is provided a display device including: an image providing device configured to provide an image; a polarization modulation device configured to modulate a polarization state of each pixel in the image provided by the image providing device according to pixel-specific depth information of the image; and a birefringent optical system configured to focus the image at focal lengths determined according to the polarization state modulated by the polarization modulation device.

The image providing device may be a two-dimensional (2D) display corresponding to an organic light-emitting diode (OLED) display or a micro light-emitting diode (LED) display or a passive display corresponding to a liquid crystal display (LCD), a liquid crystal on silicon (LCoS), or a digital micromirror device (DMD).

The birefringent optical system may include at least one birefringent lens or at least one birefringent medium layer and a concave lens or a convex lens, and the birefringent lens or the birefringent medium layer may have different refractive indices according to a polarization state of incident light and have different focal lengths with respect to orthogonal beams of polarized light.

When the number of birefringent lenses or birefringent layers is n, the number of focal lengths that can be generated through the birefringent optical system may be 2ⁿ.

Magnification ratios of the image passed through the birefringent optical system may be increased in proportion to the focal lengths, and images focused at the respective focal lengths may overlap each other.

The polarization modulation device may correspond to a polarization switch for converting a polarization state of the overall image into orthogonal polarization states, and the polarization switch may alternately switch the polarization state of the overall image at a specific rate such that the images focused at different focal lengths may be alternately output.

A brightness ratio of the image passed through the birefringent optical system may be determined on the basis of a polarization axis of the birefringent optical system and a polarization axis modulated by the polarization modulation device.

A brightness ratio of the image may be an internal dividing point of a diopter distance of a pixel-specific depth of the image.

The display device may further include, when the polarization modulation device is a reflective type, a half mirror configured to change an optical path of an image reflected from the reflective polarization modulation device, and the reflective polarization modulation device has one surface formed of a mirror such that the image incident on the reflective polarization modulation device and modulated in polarization may be returned in a direction in which the image has been incident.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram showing a configuration of a display device according to an exemplary embodiment of the present invention;

FIGS. 2A and 2B is a set of example views illustrating polarization modulation;

FIG. 3 is a diagram showing a birefringent optical system according to an exemplary embodiment of the present invention;

FIG. 4 is a diagram illustrating a case in which a plurality of birefringent lenses are used;

FIG. 5 is a set of diagrams illustrating a method of providing an image using a polarization switch;

FIG. 6 is a set of diagrams illustrating a method of adjusting a brightness ratio of an image;

FIGS. 7A and 7B is a set of diagrams illustrating a display device employing a birefringent optical system to which a structure of a telephoto lens is applied; and

FIG. 8 is an example view illustrating a three-dimensional (3D) image generated according to an exemplary embodiment of the present invention.

### DETAILED DESCRIPTION OF EXEMPLARY EMBODIMENTS

Advantages and features of the present invention and methods for achieving them will be made clear from embodiments described in detail below with reference to the accompanying drawings. However, the present invention is not limited to the embodiments disclosed below and may be implemented in a variety of different forms. The embodiments are provided only to fully disclose the present invention and completely inform those of ordinary skill in the art of the category of the present invention. The present invention is defined by only the scope of the claims. Throughout the specification, like reference numerals refer to like elements. The term “and/or” refers to and encompasses any of stated items and all combinations of one or more thereof.

Although the terms, such as “first” and “second,” are used to describe various elements, components, and/or sections, the elements, components, and/or sections are not limited by the terms. The terms are used only to distinguish one element, component, or section from other elements, components, or sections. Therefore, a first element, a first component, or a first section discussed below may be termed a second element, a second component, or a second section within the technical spirit of the present invention.

Terminology used herein is for the purpose of describing embodiments of the present invention only and is not intended to limit the present invention. The singular forms are intended to include the plural forms as well, unless the context clearly indicates otherwise. The terms “comprises” and/or “comprising,” when used herein, specify the presence of stated components, steps, operations, and/or elements, but do not preclude the presence or addition of one or more other components, steps, operations, and/or elements.

Unless otherwise defined, all terms (including technical and scientific terms) used herein have the same meaning as commonly understood by those of ordinary skill in the art to which the present invention pertains. Terms defined in commonly used dictionaries are not interpreted in an idealized or overly formal sense unless expressly so defined herein.

In describing embodiments of the present invention, when it is determined that a detailed description of a known function or configuration may unnecessarily obscure the gist of the present invention, the detailed description will be omitted. Terms which will be described below are defined in consideration of functionality in embodiments of the present invention, which may vary according to an intention of a user or an operator, a usual practice, or the like. Therefore, definitions thereof should be made on the basis of the overall content of this specification.

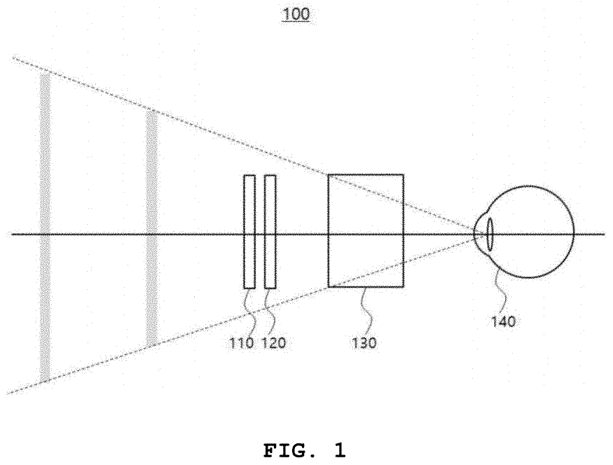

FIG. 1 is a diagram showing a configuration of a display device according to an exemplary embodiment of the present invention.

Referring to FIG. 1, a display device 100 includes an image providing device 110, a polarization modulation device 120, and a birefringent optical system 130. The image providing device 110 and the polarization modulation device 120 may be stacked on each other, and a user's eye 140 may observe an image, which is provided from the image providing device 110 and passed through the polarization modulation device 120, through the birefringent optical system 130.

The image providing device 110 is a device for providing an image. For example, the image providing device 110 may be a two-dimensional (2D) display corresponding to an organic light-emitting diode (OLED) display or a micro light-emitting diode (LED) display or a passive display corresponding to a liquid crystal display (LCD), a liquid crystal on silicon (LCoS), or a digital micromirror device (DMD).

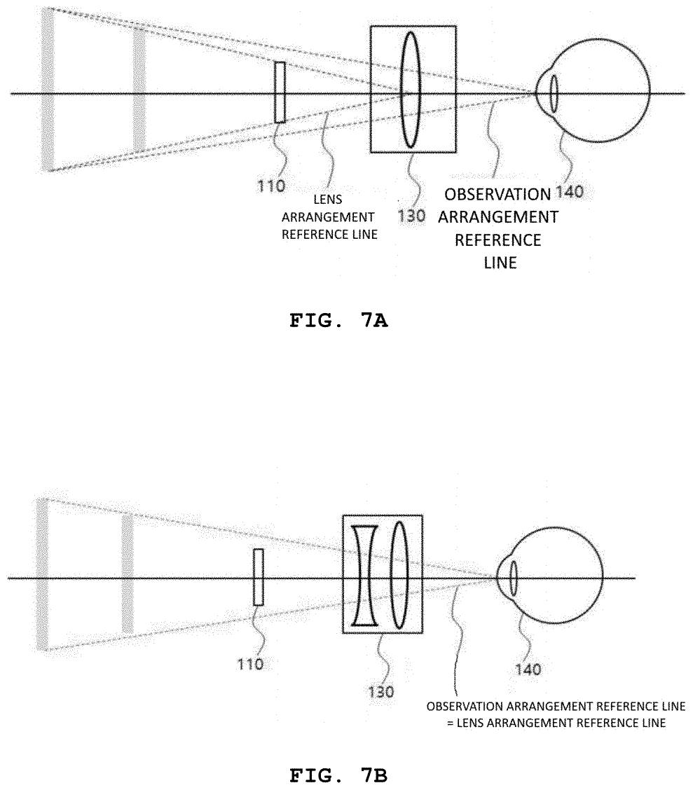

The polarization modulation device 120 is a device for maintaining the light intensity of an image and modulating a polarization state of the image differently according to pixel-specific depth information. The polarization modulation device 120 modulates polarization states of respective pixels in an image provided by the image providing device 110 according to pixel-specific depth information of the image. The polarization modulation device 120 may modulate a polarization state of an incident image from 0 degrees to 90 degrees in units of pixels. The polarization modulation device 120 may correspond to a transmissive spatial light modulator or a reflective spatial light modulator. FIG. 1 shows a configuration when a transmissive spatial light modulator is used, and a case in which a reflective spatial light modulator is used will be described below with reference to FIG. 7.

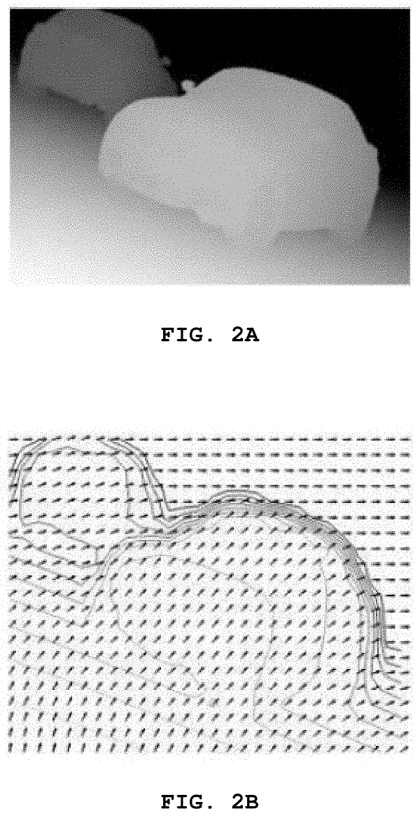

The polarization modulation device 120 may convert depth information of an image provided by the image providing device 110 as shown in FIG. 2A into a polarization modulation map shown in FIG. 2B. In FIG. 2B, each arrow represents a polarization state. More specifically, the polarization modulation device 120 has a structure in which a liquid crystal layer having photoanisotropy (a characteristic that refractive index has a value varying according to a molecular orientation) is interposed between transparent electrodes. Due to this structure, light polarized in one direction is passed through the liquid crystal layer and acquires different phase delays according to polarization directions because refractive indices according to respective polarization directions are different due to the photoanisotropy. Therefore, a vector sum represented by the sum of respective polarization components is shown as final polarization.

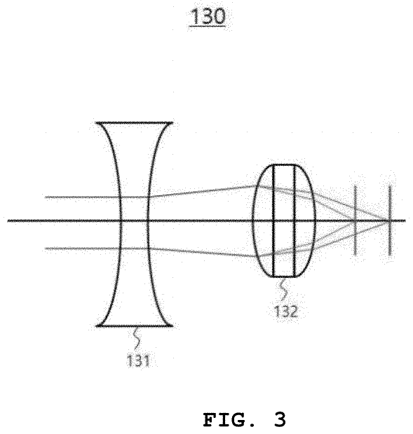

The birefringent optical system 130 causes an image to be focused at a focal length determined according to a polarization state modulated by the polarization modulation device 120. Referring to FIG. 3, the birefringent optical system 130 includes at least one birefringent lens 132 or at least one birefringent medium layer and includes a concave lens 131 or a convex lens. The birefringent lens or birefringent medium layer gives different refractive indices according to polarization states of incident light and gives different focal lengths with respect to orthogonal beams of polarized light. For example, a crystalline material, such as calcite, has different refractive indices depending on crystal orientations. When a lens is made of such a crystalline material, a refractive index of light varies according to an optical axis direction of the lens. Since an optical axis is related to a polarization state, it is possible to give different focal lengths with respect to orthogonal beams of polarized light, and on this principle, a lens made of birefringent material, that is, a birefringent lens, is able to have two different focal lengths according to different polarization states which are orthogonal to each other. In other words, the birefringent lens 132 provides different refractive indices according to polarization states of incident light as indicated by a blue line and a red line in FIG. 3 such that focuses may be formed at different focal lengths. Also, the birefringent medium layer may be, for example, a savart plate.

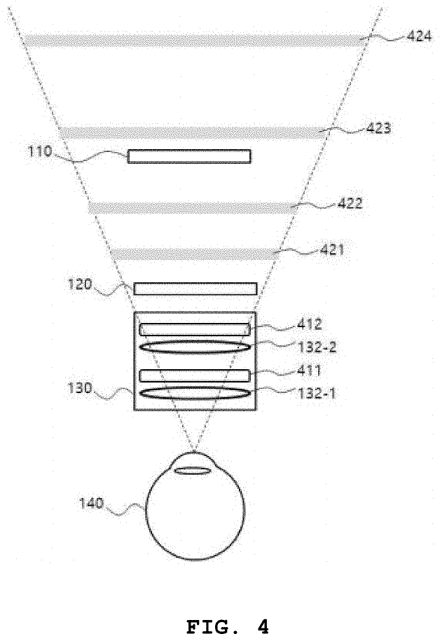

When the number of birefringent lens or birefringent medium layers constituting the birefringent optical system 130 is n, the number of focal lengths that may be generated through the birefringent optical system 130 is 2ⁿ. For example, when a birefringent lens has focuses corresponding to diopters of f1 and f2 according to the polarization states, it is possible to obtain four focal length combinations of f1+f1, f1+f2, f2+f1, and f2+f2 according to polarization states using two identical birefringent lenses. Therefore, when n birefringent lenses are used, it is possible to implement 2ⁿ focal length combinations according to polarization states. For example, referring to FIG. 4, the birefringent optical system 130 includes two birefringent lenses 132-1 and 132-2 and two polarization switches 411 and 412. When two or more birefringent lenses are included, the birefringent lenses and polarization switches may be make one combination, and the polarization modulation device 120 may be additionally included. Since the birefringent optical system 130 employs two birefringent lenses in FIG. 4, the number of focal lengths that may be generated through the birefringent optical system 130 is 4.

Magnification ratios of an image passed through the birefringent optical system 130 may be increased in proportion to focal lengths, and images formed at the respective focal lengths may overlap each other. To this end, a polarization switch for converting polarization states of an overall image into orthogonal polarization states may be used as the polarization modulation device 120, and the polarization switch may alternately switch the polarization state of the overall image at a specific rate such that images focused at different focal lengths may be alternately output. As a kind of the polarization modulation device 120, the polarization switch does not modulate polarization in units of pixels and uniformly modulates polarization of the entire area of the polarization switch, that is, an overall image coming into the polarization switch.

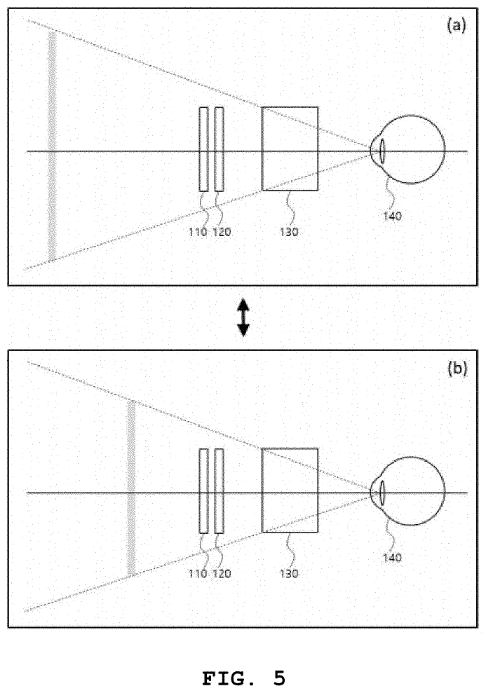

In other words, the polarization switch is used to modulate polarization states of a short-distance image and a long-distance image at a higher rate than a time resolution which is recognizable by a user, for example, 30 Hz or more, such that the images having different depths may be simultaneously observed by a user. As an example, the polarization modulation device 120 implemented as a polarization switch alternately modulates a polarization state of an image at a rate of 30 Hz or more such that a long-distance image and a short-distance image may be alternately provided as shown in FIGS. 5A and 5B, respectively. Then, a user is able to observe a three-dimensional (3D) image.

The birefringent optical system 130 may adjust brightness ratios of a long-distance image and a short-distance image with respect to an image whose polarization has been modulated by the polarization modulation device 120. A brightness ratio of an image passed through the birefringent optical system 130 may be determined by [Equation 1] below on the basis of a polarization axis of the birefringent optical system 130 and a polarization axis modulated by the polarization modulation device 120. A brightness ratio of an image may be an internal dividing point of a diopter distance of a pixel-specific depth of the image.

Iₙₑₐᵣ=I₀ cos²(θ_{near_axis}−θ_{modulated})

I_{far}=I₀ cos²(θ_{far_axis}−θ_{modulated}) [Equation 1])

Here, Iₙₑₐᵣ is brightness at a short distance, I_{far} is brightness at a long distance, I₀ is an intensity of incident light, θ_{near_axis} and θ_{far_axis} are polarization axes of the birefringent optical system 130, and θ_{modulated} is a polarization state of an image modulated through the polarization modulation device 120.

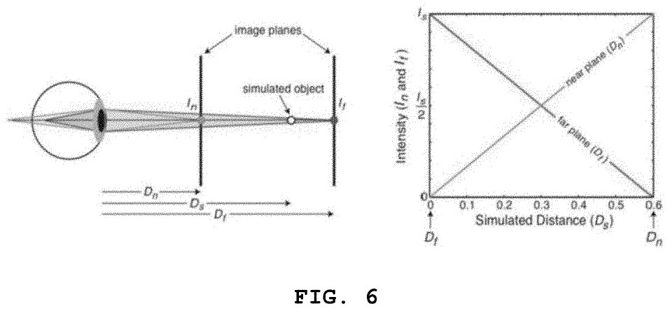

More specifically, referring to FIG. 6, a depth and brightness of an image have a relationship as represented by [Equation 2] below, and [Equation 2] may be represented by [Equation 3] with respect to Dₛ.

$$\begin{matrix}{I}_{n} = [ 1 - \frac{( {D}_{n} - {D}_{s} )}{( {D}_{n} - {D}_{f} )} ] {I}_{s} \\ {I}_{f} = [ \frac{( {D}_{n } - {D}_{s} )}{( {D}_{n} - {D}_{f } )} ] {I}_{s} , \\ {I}_{s} = {I}_{n} + {I}_{f} & [ Equation 2 ] \\ {D}_{s} = {D}_{n} - \frac{{I}_{n}}{{I}_{s}} ( {D}_{n} - {D}_{f} ) \\ {D}_{s} = {D}_{f} + \frac{{I}_{f}}{{I}_{s}} ( {D}_{n} - {D}_{f} ) & [ Equation 3 ]\end{matrix}$$

Here, Iₙ is brightness at a short distance, I_{f} is brightness at a long distance, Iₛ is brightness of an observed image, Dₙ is a depth of a short-distance image, D_{f} is a depth of a long-distance image, and Dₛ is a depth at which the short-distance image and the long-distance image are observed. Referring to [Equation 3], it is possible to see that Dₛ is obtained by internally dividing the depth (Dₙ−D_{f}) between the short-distance image and the long-distance image using a brightness ratio (I_{f}/Iₛ or Iₙ/Iₛ) as a weight.

In [Equation 2] and [Equation 3], Iₙ and I_{f} have the same concepts as Iₙₑₐᵣ and I_{far} of [Equation 1], respectively. To implement a corresponding brightness, polarization modulation is applied, and brightness I of an image observed through polarization modulation is determined by Malus' law as shown in [Equation 4] below. Malus' law indicates that because a polarized image modulated in an LCD passes through a polarizer, an intensity of light corresponds to the square of the cosine of the angle between an optical axis of the polarizer and an optical axis of modulated polarization.

I=I₀ cos² θᵢ [Equation 4]

Here, θ₁ is a polarization angle difference between the polarization axis of the birefringent optical system 130 and an image incident on the birefringent optical system 130. In other words, [Equation 1] represents, on the basis of [Equation 4], that brightness of short-distance and long-distance images is determined according to the polarization axis θₙₑₐᵣ axis of the birefringent optical system 130 and the polarization state θ_{modulated} of an image incident on the birefringent optical system 130 through the polarization modulation device 120.

FIG. 7 is a set of diagrams illustrating a display device employing a birefringent optical system to which a structure of a telephoto lens is applied.

A method of rapidly and alternately outputting images using a polarization switch has been described above with reference to FIG. 5, so that a magnification ratio of an image passed through the birefringent optical system 130 may be increased in proportion to a focal length and images focused at respective focal lengths may be observed in a superimposed state. From now, a method of applying a structure of a telephoto lens is described, so that a long-distance image and a short-distance image may be observed in a superimposed state.

Referring to FIG. 7A, in this configuration, a single-lens optical system is used in a time division manner. It is possible to see that a structure of a telephoto lens is not employed and a magnification ratio observed through the lens and a magnification ratio observed at a user's position are at different positions. In other words, a lens arrangement reference line and an observation arrangement reference line do not coincide with each other. However, a telephoto lens has a structure whose principal planes, which are reference points for calculating a position on the lens and a magnification ratio of an image, are outside the lens. Therefore, when the structure of the telephoto lens is applied to the birefringent optical system of the present invention, it is possible to make a lens arrangement reference line and an observation arrangement reference line coincide with each other as shown in FIG. 7B.

More specifically, when the birefringent optical system 130 is configured in the same structure as a telephoto lens as shown in FIG. 7B, a reference plane for calculating a lens magnification is positioned outside the lens, and when the eye 140 is positioned on the reference plane, it is possible to make a lens arrangement reference line and an observation arrangement reference line coincide with each other. In other words, the birefringent optical system 130 may be a combination of a concave lens and a convex lens or a birefringent lens, and the concave lens and the convex lens may be arranged in order of a virtual image, the concave lens, the convex lens, and an observer. A lens may be added thereto for a reduction in aberration and the like, and focuses of the respective lenses or the interval between the lenses may be readily changed by those of ordinary skill in the art according to a system in which the corresponding display device is employed. Although a polarization modulation device is not shown in FIG. 7, a polarization modulation device is included in the display device of FIG. 7B like the above-described exemplary embodiment.

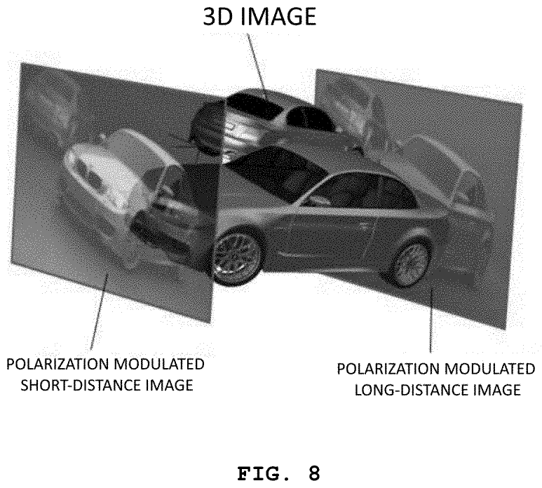

FIG. 8 is an example view illustrating a 3D image generated according to an exemplary embodiment of the present invention.

FIG. 8 shows a 3D image generated by a display device according an exemplary embodiment of the present invention. An image transferred from the image providing device 110 to the polarization modulation device 120 is modulated in polarization according to pixel-specific depth information, and the polarization modulated image is formed at a short distance or a long distance through the birefringent optical system 130. Therefore, it is possible to provide a polarization modulated short-distance image or a polarization modulated long-distance image as shown in FIG. 8. Also, each of the short-distance image and long-distance image may be adjusted in magnification ratio and brightness ratio through the birefringent optical system 130 to show depth-fused 3D effects. A user is able to view a 3D image at an observation depth between the depth of the short-distance image and the depth of the long-distance image. In other words, according to an exemplary embodiment of the present invention, a brightness ratio of an image positioned on the same viewing axis is adjusted on image planes positioned at different depths. Therefore, the image may seem to exist at any position between the two depths. Since this is based on focus adjustment, it is possible to solve vergence-accommodation conflict which is the problem of visual fatigue using the display device according to an exemplary embodiment of the present invention.

According to exemplary embodiments of the present invention, a multifocal surface can be implemented by only polarization modulation without providing images in a time or space division manner, and accordingly, it is possible to implement high resolution and a low response delay rate. Therefore, it is possible to prevent dizziness, motion sickness, etc. of a virtual reality (VR) or augmented reality (AR) display. Also, multiple focuses cause less visual fatigue such that headache, motion sickness, etc. can be mitigated.

Since the present invention employs a birefringent optical system in a polarization modulation scheme, image quality is barely degraded, and it is possible to simplify a projection optical system of the existing polarization modulation scheme, that is, it is possible to reduce the volume and weight of a system. Also, since depth adjustment information can be provided to a monocle or a binocle, it is possible to implement a natural AR or VR image.

Since the present invention makes it possible to provide multiple focuses not in a time division manner, a delay time of an image can be minimized. Even when a time division manner is used, it is possible to further simplify a system structure by employing a single-lens optical system.

A display device according to an exemplary embodiment of the present invention can be implemented as an AR structure by using a reflective spatial light modulator.

Although exemplary embodiments of the present invention have been described in detail above, the present invention pertains is not limited thereto. Various modifications can be made within the claims, the detailed description of the present invention, and the accompanying drawings and fall within the scope of the present invention.

What is claimed is:

1. A display device comprising:
an image providing device configured to provide an image;
a polarization modulation device configured to modulate a polarization state of each pixel in the image provided by the image providing device according to pixel-specific depth information of the image; and
a birefringent optical system configured to cause the image to be formed at focal lengths determined according to the polarization state modulated by the polarization modulation device.

2. The display device of claim 1, wherein the image providing device is a two-dimensional (2D) display corresponding to an organic light-emitting diode (OLED) display or a micro light-emitting diode (LED) display or a passive display corresponding to a liquid crystal display (LCD), a liquid crystal on silicon (LCoS), or a digital micromirror device (DMD).

3. The display device of claim 1, wherein the birefringent optical system includes at least one birefringent lens or at least one birefringent medium layer and a concave lens or a convex lens, and
the birefringent lens or the birefringent medium layer has different refractive indices according to a polarization state of incident light and has different focal lengths with respect to orthogonal beams of polarized light.

4. The display device of claim 3, wherein when the number of birefringent lenses or birefringent layers is n, the number of focal lengths that can be generated through the birefringent optical system is 2ⁿ.

5. The display device of claim 1, wherein magnification ratios of the image passed through the birefringent optical system are increased in proportion to the focal lengths, and
images formed at the respective focal lengths overlap each other.

6. The display device of claim 5, wherein the polarization modulation device corresponds to a polarization switch for converting a polarization state of the overall image into orthogonal polarization states, and
the polarization switch alternately switches the polarization state of the overall image at a specific rate such that images focused at different focal lengths are alternately output.

7. The display device of claim 1, wherein a brightness ratio of the image passed through the birefringent optical system is determined on the basis of a polarization axis of the birefringent optical system and a polarization axis modulated by the polarization modulation device.

8. The display device of claim 7, wherein the brightness ratio of the image is an internal dividing point of a diopter distance of a pixel-specific depth of the image.

9. The display device of claim 1, further comprising, when the polarization modulation device is a reflective type, a half mirror configured to change an optical path of an image reflected from the reflective polarization modulation device,
wherein the reflective polarization modulation device has one surface formed of a mirror such that the image incident on the reflective polarization modulation device and modulated in polarization is returned in a direction in which the image has been incident.
